(19) United States
(12) Patent Application Publication
(10) Pub. No.: US 2003/0225508 A9
(43) Pub. Date: Dec. 4, 2003

(54) Navigational system

(76) Inventors: Bernd Petzold, Edemissen (DE); Gerd Draeger, Braunschweig (DE)

Correspondence Address: KENYON & KENYON, ONE BROADWAY, NEW YORK, NY, 10004, US

(21) Appl. No.: 09/960,563

(22) Filed: Sep. 12, 2001

(30) Foreign Application Priority Data
Sep. 12, 2000 (DE) 100 44 935.2

(51) Int. Cl. G01C 21/32

(52) U.S. Cl. 701/201; 701/209

(57) ABSTRACT

Proposed is a navigational system (1), which provides a user with a plurality of routes between a starting point (S) and a destination (Z) for selection. The navigational system (1) includes a calculation unit (400) for calculating a first route (5) from starting point (S) to destination (Z). It further includes a reproducing device (700) for reproducing the calculated first route (5). The calculation unit (400) calculates at least one second route (10), which differs from first route (5), from starting point (S) to destination (Z). The reproducing device (700) reproduces the at least one calculated second route (10) in addition to the first route (5).

### BACKGROUND INFORMATION

The present invention relates to a navigational system according to the definition of the species of the main claim.

Navigational systems having a calculation unit for calculating a route from a starting point to a destination point and having a reproducing device for reproducing the calculated route are already known.

### SUMMARY OF THE INVENTION

In contrast, the navigational system according to the present invention and having the features of the main claim has the advantage that the calculation unit calculates at least one second route, which differs from the first route, from the starting point to the destination, and that the reproducing device reproduces the at least one calculated second route in addition to the first route. In this manner, the user of the navigational system can be presented with a plurality of alternative routes from which the user selects a route that is suited to his needs.

Advantageous further refinements and improvements of the navigational system specified in the main claim are possible as a result of the measures indicated in the dependent claims.

It is particularly advantageous that a selection unit for selecting one of the reproduced routes is provided, and that a route guidance unit is provided that produces navigational information for a position between the starting point and the destination on the selected route and conveys it to the reproducing device for reproduction. In this manner, the user can be guided from the starting point to the destination, on the route selected according to his needs, thereby creating a particularly user-adapted navigational system.

It is particularly advantageous that the different routes are reproduced on the reproduction unit as a function of at least one predefined route criterion. In this manner, the user can have the different routes displayed according to one or more route criteria and receives in this manner a qualitative characterization of the reproduced routes that aids him in selecting a route that is suited to his needs.

A further advantage is that a weighting of the at least one route criterion can be input at the input unit or can be fixed. In this manner, the reproduction of the calculated routes can already be qualitatively classified according to the weighting, so that it is even simpler to select one route that is suited to the user's needs since the user can make a decision according to the provided qualitative classification, without further deliberation and, thus, particularly quickly. A further advantage is that input means for manipulating or changing at least one of the routes reproduced on the reproducing device are provided, and that a manipulated or changed route is able to be selected for navigation. In this manner, the user himself can use the calculated and reproduced routes to create a new route, which can differ from the reproduced routes, and which best meets the user's needs. The navigational system can be even further adapted to the user's needs in this manner.

It is particularly advantageous that a communications unit is provided that receives information regarding traffic disruptions, in particular traffic flow, on the calculated routes, and that the reproducing device reproduces this information. In this manner, the user of the navigational system is also informed about the current state of traffic on the calculated and reproduced routes, so that he can take the current state of traffic into account when selecting a route that is suited his needs. Therefore, the reproduced information can also provide the user of the navigational system with a qualitative classification of the calculated routes, thereby enabling the user to more clearly and more quickly select a route that is adapted to his needs.

A further advantage is that the reproducing device reproduces the information regarding traffic disruptions in conjunction with the calculated routes. In this manner, the clarity of the reproduction is increased, and the user can more quickly select a route that is suited to his needs, because he perceives all relevant information at the same time. The traffic disruptions can be reproduced in a particularly clear manner in the form of isolines or an isographic diagram.

It is particularly advantageous that in response to receiving information regarding a traffic disruption on the selected route, the calculation unit calculates at least one further route, which differs from the selected route, starting from the current position as the new starting point to the preselected destination, and that the reproducing device reproduces the at least one additional calculated route for selection, in addition to the selected route. In this manner, the user can react early to traffic disruptions on the selected route while traveling from the original starting point to the predefined destination and can switch to a new alternative route calculated in response to the detected traffic disruption in order to avoid this traffic disruption. Thus, the selected route can be actualized, thereby also making it possible to adapt the selected route to the user's needs.

A further advantage is that the received information also includes the type of traffic disruption, and that the reproducing device reproduces the type of traffic disruption. In this manner, the user of the navigational system receives an additional decision aid regarding the quality of the traffic disruption, thereby enabling the user to better assess the proposed alternative route.

### BRIEF DESCRIPTION OF THE DRAWING

Exemplary embodiments of the invention are shown in the drawings and are explained in greater detail in the following description.

FIG. 1 shows a block diagram of a navigational system according to the present invention;

FIG. 2 shows a representation of traffic disruptions on a map in the form of isolines;

FIG. 3 shows a representation of traffic disruptions on a map in the form of an isographic diagram;

FIG. 4 shows a representation of a map having a selected route and alternative routes in response to the occurrence of a traffic disruption on the selected route;

FIG. 5 shows the representation of a selected calculated route from a starting point to a destination;

FIG. 6 shows a representation of alternative routes on a map;

FIG. 7 shows the representation of a selected routed from a starting point to a destination on a map for the navigational system's current position between the starting point and the destination;

FIG. 8 shows a representation of alternative routes starting from such a current position of the navigational system between the original starting point and the destination;

FIG. 9 shows a superimposed representation of a selected route, including information regarding traffic disruptions; and

FIG. 10 shows a superimposition of the selected route, including information regarding traffic disruptions and an additional representation of alternative routes.

### DESCRIPTION OF THE EXEMPLARY EMBODIMENTS

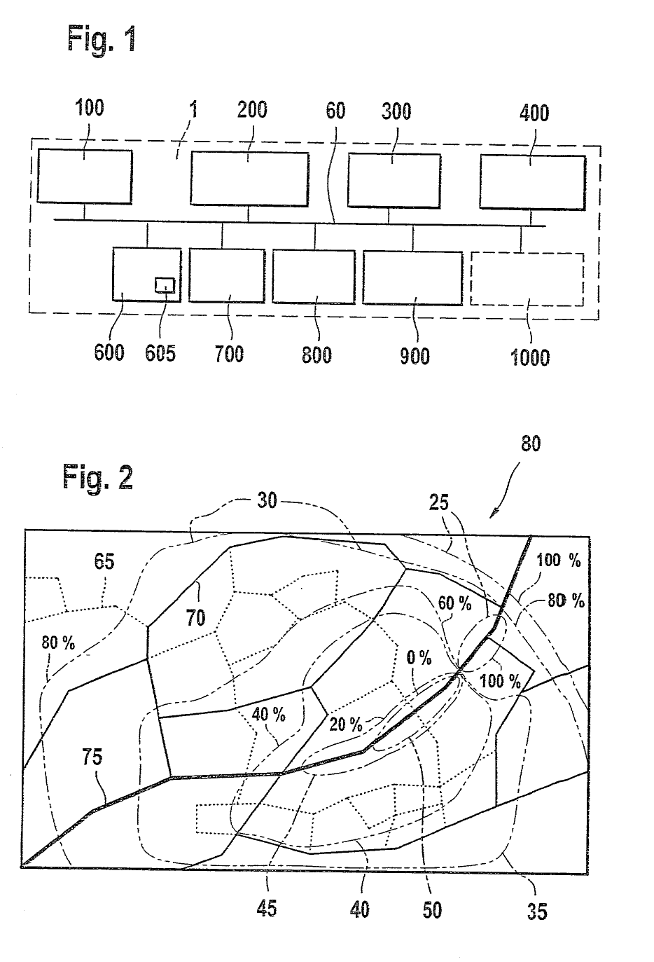

In FIG. 1, reference numeral 1 designates a navigational system. In the following, navigational system 1 is to be arranged in a motor vehicle, for example. The system includes a memory 100, in which a digital map in stored. Navigational system 1 further includes a position-determining unit 300 for determining a current position of navigational system 1, i.e., of the motor vehicle. This can be carried out with the aid of a GPS receiver (global positioning system). Navigational system 1 further includes a calculation unit 400 for calculating travel routes from a predefined starting point S to a preselected destination Z. Navigational system 1 further includes an input unit 600, which includes input means 605. Navigational system 1 also includes a reproducing device 700, which can include an optical display device and/or an acoustic reproducing device. Navigational system 1 further includes a route guidance unit 800, which generates route guidance information for an instantaneous position of navigational device 1, i.e., the motor vehicle, between starting point S and destination Z on a selected route and transmits it to reproducing device 700 for reproduction. Navigational system 1 further includes a selection unit 900 for selecting one of the routes reproduced on reproducing device 700, so that route guidance unit 800 can generate route guidance information for positions on such a selected route between starting point S and destination Z. Optimally, navigational system 1 can also include a communications unit 1000, which receives information regarding traffic disruptions on the routs calculated by calculation unit 400 and transmits it to reproducing device 700 for reproduction. The indicated components of navigational system 1 are connected to one another via a databus 60 and can exchange data with one another in this manner. In this context, the data exchange on databus 60 is managed by a management unit 200, which is also connected to databus 60.

The functioning method of navigational system 1 is explained more closely in the following.

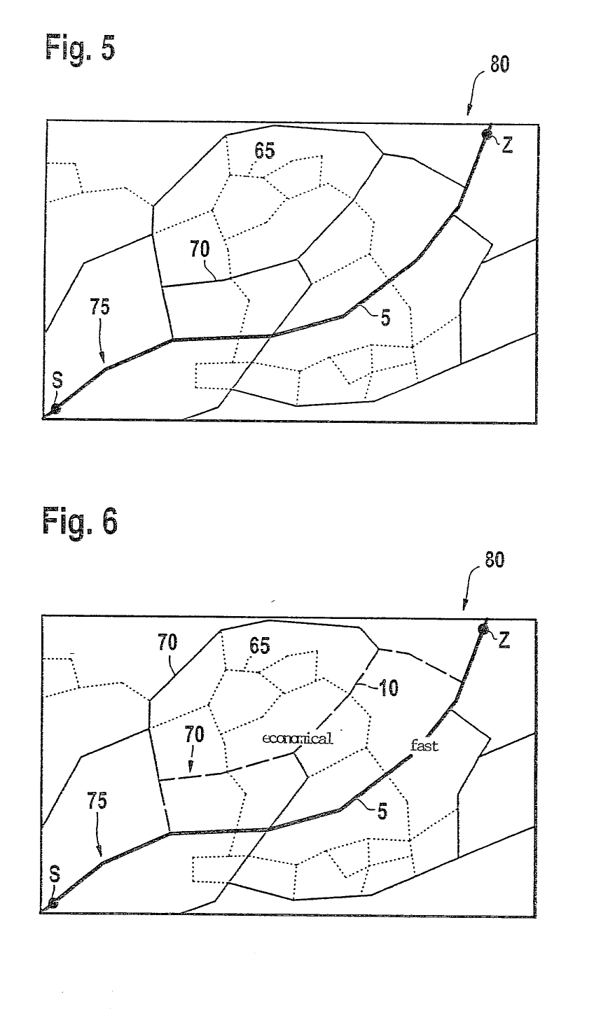

According to FIG. 5, the vehicle including navigational system 1 is located at starting point S, as shown on a map 80. In the following, it is to be assumed, for example, that reproducing device 700 includes an optical display device, e.g. a display, which displays map 80 in a digitalized form. On this map 80, side roads are designated by reference numeral 65, main roads by reference numeral 70, and a highway by reference numeral 75. In this context, starting point S is determined by position determining unit 300. The user of navigational system 1, i.e., the driver of the motor vehicle, inputs desired destination Z at input unit 600, destination Z also being represented on map 80 according to FIG. 5. As a result of a further input at input unit 600 or automatically after destination Z is input, calculation unit 400 calculates a first route 5 from starting point S to destination Z, the route completely following highway 75 on map 80 according to FIG. 5. This first route 5 is distinctly marked on the optical display device, e.g. by coloring first route 5 on map 80, by highlighting first route 5 by framing the road sections or highway sections in question, by marking first route 5 using arrows that point from starting point S to destination Z, or using textual representation of the roads used for first route 5 in the form of a list.

The present invention provides that the calculation unit calculates at least one second route 10 from starting point S to destination Z, the second route differing from first route 5 and being represented on the optical display device in addition to first route 5. This is represented in FIG. 6, in which identical reference numerals designate the same parts as in FIG. 5. Starting from first route 5 according to FIG. 5, map 80 according to FIG. 6 additionally shows second route 10, which also follows highway 75 in the region of starting point S and destination Z, but proposes a connection via main road 70 in between those two points. In this context, the different routes 5, 10 can be reproduced on the optical display device as a function of at least one predefined route criterion. In this context, the at least one route criterion can be input by the user at input unit 600 or can be fixed and stored in management unit 200. In the present example according to FIG. 6, the route criteria, fuel consumption and travel time, were preselected, calculation unit 400 designating first route 5 as quick and second route 10 as economical when displayed on the optical display device. The user can now decide whether he wants to select first route 5 or second route 10 at selection unit 900, route guidance unit 800 generating route guidance information for positions of navigational system 1, i.e., of the motor vehicle, between starting point S and destination Z on selected route 5 after the selection and transmitting the information to be represented on the optical display device. The traffic jam risk (probability), the maximum or average attainable speed, the distance of the travel route, and/or the like can be selected as route criteria at input unit 600 or can be fixed. Furthermore, it can be provided to select one or more so-called avoidance regions (regions to be avoided) through which the routes calculated by calculation unit 400 should not travel. It is also possible to input a weighting of the at least one route criterion at input unit 600, such a weighting also being able to be fixed and stored in management unit 200. Such a weighting can be carried out in such a manner that, e.g., the routes calculated by calculation unit 400 are evaluated according to travel time as route criterion and according to traffic jam probability as weighting and are represented with the appropriate designation on the optical display device. In this manner, mixed route criteria can be generated. Thus, it can be provided, for example, that the routes calculated by calculation unit 400 as the fastest route having a 10% traffic jam probability, the fastest route having a 20% traffic jam probability, the fastest route having a 30% traffic jam probability, etc. are graphically presented on map 80 for selection. The route criterion, travel time, is thus weighted as described by the route criterion, traffic jam probability.

It can be further provided that the user of navigational system 1 is not committed to the routes presented on the optical display device for selection at selection unit 900, but can create a new route based on the routes calculated by calculation unit 400. This can be carried out in that input means 605 are provided at input unit 600, e.g. in the form of a mouse pointer or cursor keys, via which individual road segments on map 80 can be marked. The marked road segments can then be included in a new route by operating a confirmation key at input unit 600, thereby resulting in a route created by the user of navigational system 1. Therefore, in this manner, the user of navigational system 1 can create a new route, which is then reproduced on the optical display device for selection by selection unit 900. If this route is selected by the user, route guidance unit 800 uses corresponding route guidance information to guide the user on this new route created by the user himself from starting point S to destination Z.

FIG. 2 shows map 80 without starting point S and destination Z being designated and also without a route calculated by calculation unit 400 being marked. Information regarding traffic disruptions on routes 5, 10, which are calculated by calculation unit 400, are received via optional communications unit 1000, which can be connected to a cellular network via an air interface or can be configured for receiving radio broadcast signals, and the information is represented by reproducing device 700 or the optical display device. In this context, the representation can occur separately from calculated routes 5, 10, is shown in FIG. 2. In this context, the traffic disruptions are reproduced by the optical display device in the form of isolines 25, 30, 35, 40, 45, 50, the isolines representing boundaries of traffic disruptions having a constant size. The traffic disruptions can, in this context, be reproduced using information about the traffic flow, for example. However, they can also be expressed by the attainable, average top speed, the traffic jam probability, the unavoidable average time delay, etc. According to FIG. 2, the traffic disruptions in the form of the traffic flow are indicated in a percentage. The smaller the percentage is, the lighter the traffic flow is. In this context, the traffic flow can fluctuate between 0%, i.e. standstill, and 100%, i.e., no traffic hindrances. On map 80 according to FIG. 2, such isolines are drawn for the traffic flow, a first isoline 25 designating traffic flow at 100%, a second isoline 30 designating traffic flow at 80%, a third isoline 35 designating traffic flow at 60%, a fourth isoline 40 designating traffic flow at 40%, a fifth isoline 45 designating traffic flow at 20%, and a sixth isoline 50 designating traffic flow at 0%. In this context, according to FIG. 2, sixth isoline 50 indicates a route segment in the region of highway 75, having a traffic flow of 0%, a route segment indicated by first isoline 25 and having a traffic flow of 100% being directly adjacent and opposite.

In FIG. 2, the same reference numerals again also designate the same elements as in the previously described figures.

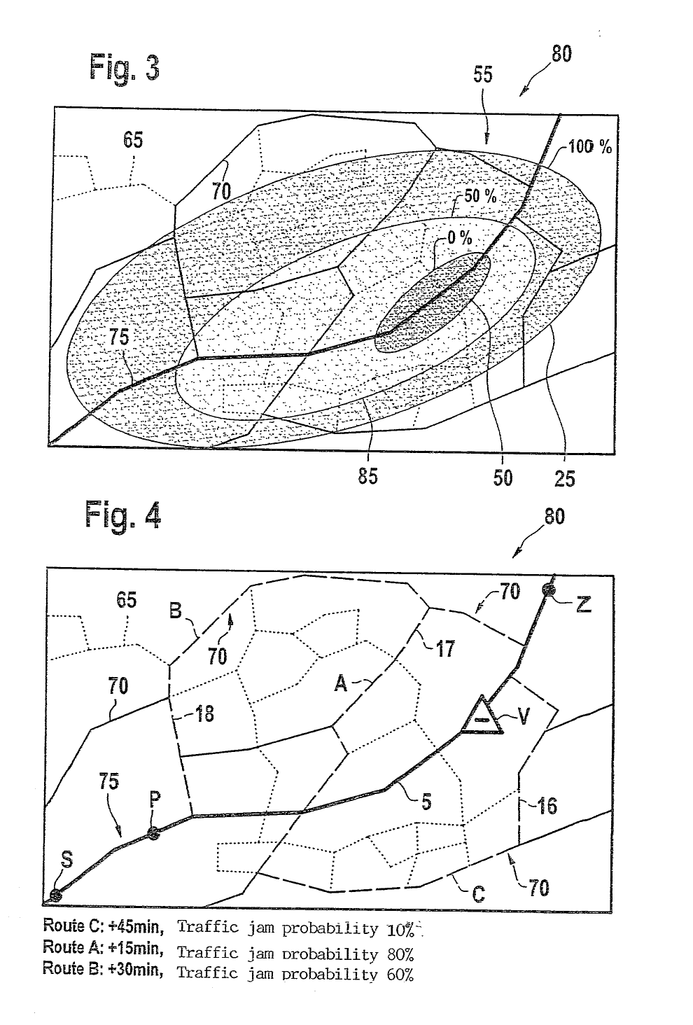

The traffic disruptions can also be reproduced on the optical display device in the form of an isographic diagram 55 according to FIG. 3, in which the different regions between the isolines are represented using a different color or brightness. In this context, starting from the map 80 already represented in FIG. 2, first isoline 25, sixth isoline 50, and a seventh isoline 85 having a traffic flow at 50% are represented, the isolines lying differently than in the example according to FIG. 2, yet a route segment of highway 75 again being in a region having a traffic flow at 0% since the route segment is enclosed by sixth isoline 50 as in FIG. 2. The regions enclosed by an isoline are also called isosurfaces. In FIGS. 3, these are each indicated by different gray-scale values. Their traffic flow corresponds at least to the surrounding isoline. In FIG. 3, the same reference numerals again also designate the same elements as in the previously described figures.

In FIGS. 2 and 3, only the information regarding the traffic disruptions are entered on corresponding map 80, yet not the routes calculated by calculation unit 400. This renders possible a separate representation of the traffic disruptions and of routes 5, 10 calculated by calculation unit 400 on the optical display device, the representations being able to be displayed on two adjacent displays or sequentially on one display, for example.

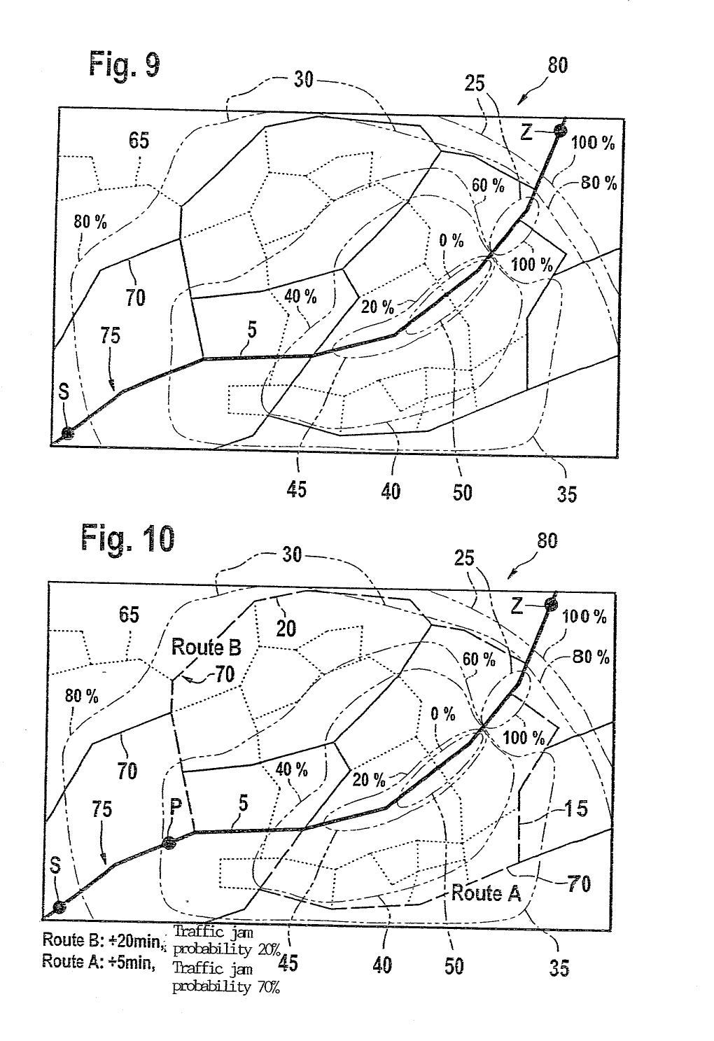

However, it is also possible to represent the traffic disruptions and the routes calculated by calculation unit 400 in a superimposed manner as shown in FIG. 9. Starting from map 80 according to FIGS. 2, 3, 5, 6, first route 5 is represented in FIG. 9, and the traffic disruptions according to FIG. 2 are superimposed in the form of isolines 25, 30, 35, 40, 45, 50. In FIG. 9, the same reference numerals again designate the same elements as in the previously described figures.

Therefore, a representation of the traffic disruptions in conjunction with at least first route 5 on map 80 can be deduced from FIG. 9.

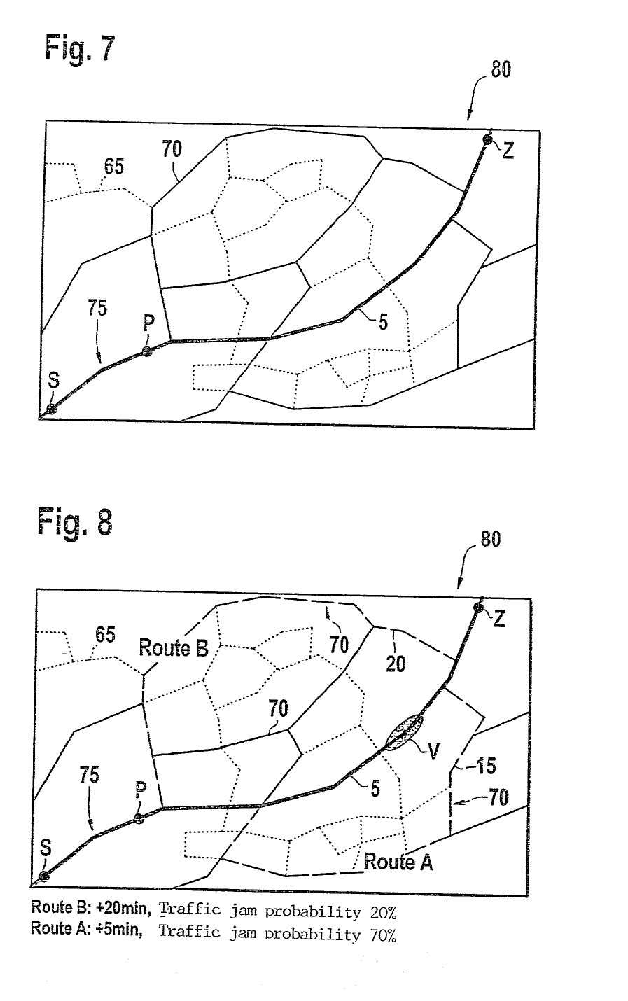

Starting from the two alternative routes 5, 10 proposed to the user according to FIG. 6, it should be assumed in the following, for example, that the user decided on the faster of the two routes, i.e., first route 5 on highway 75, and selected it at selection unit 900 for the route guidance. Thus, for positions between starting point S and destination Z on selected first route 5, route guidance unit 800 generates route guidance information that it transmits to the optical display unit to be reproduced, and that, in this manner, guides the user of navigational device 1, i.e., the driver of the motor vehicle, from starting point S to destination Z on first route 5. It is to be assumed according to FIG. 7 that the user is at an instantaneous position P between starting point S and destination Z on first route 5, i.e., on highway 75. In FIG. 7, the same reference numerals again designate the same elements as in the previous figures. In this example, when navigational device 1 according to FIG. 7 reaches current position P on map 80, communications unit 1000 receives information regarding a traffic disruption on selected first route 5. As a result, management unit 200 causes calculation unit 400 to calculate at least one additional route 15, 20 from current position P as the new starting point to predefined destination Z, which differs from selected first route 5, the reproducing device or the optical display device reproducing the at least one additional route 15, 20 calculated by calculation unit 400 in addition to selected first route 5 for selection, as shown in FIG. 8, in which the same reference numerals designate the same elements as in the previous figures.

According to FIG. 8, the optical display device shows a traffic disruption V on first route 5 between instantaneous position P and destination Z and provides suggestions as to how this traffic disruption V can be bypassed by two alternative routes 15, 20 from instantaneous position P. Both routes 15, 20 are calculated by calculation unit 400 and characterized according to the previously indicated route criteria, travel time weighted by traffic jam probability, which are present in this example. In this context, third route 15 represents a southern bypass of traffic disruption V, which only uses main roads 70 and represents a delay of 5 minutes with a traffic jam probability of 70% in comparison with first route 5. A fourth route 20 represents a northern bypass of traffic disruption V, which also only uses main roads 70 and entails a 20 minute delay with a traffic jam probability of 20% in comparison with first route 5. This information regarding delay and traffic jam probability for the individual routes 15, 20 represented on the optical display device is also reproduced on the optical display device below map 80. In this context, third route 15 is designated as route A and fourth route 20 as route B. In this context, the values for the route parameters, travel time and traffic jam probability, are calculated by calculation unit 400, the travel time resulting from the resulting maximum speed allowed on each alternative route 15, 20, and the respective traffic jam probability resulting from current traffic information such as empirical values from the past stored in the memory of management unit 200. In this context, the empirical values for the traffic jam probability can be added in a weighted manner to the current traffic information for alternative routes 15, 20, respectively, thereby resulting in the values for the traffic jam probability represented on the optical display device. The empirical values for the traffic jam probability for the individual routes or route segments are stored in management unit 200, in coordination with these route segments, the route segments themselves being stored in memory 100 for the digital map data of map 80.

If the information received by communications unit 1000 also includes the type of traffic disruption, this can also be reproduced or represented on reproducing device 700 or its optical display device, e.g. in coordination with a graphic marking of first route 5 at the location of traffic disruption V, as represented in FIG. 8 by a thickening of first route 5.

FIG. 4 shows an alternative exemplary embodiment to FIG. 8, where, starting from the same initial situation as in FIG. 8, calculation unit 400 calculates three alternative routes 16, 17, 18 and transmits them to be reproduced on reproducing device 700 or its optical display device. A fifth route 16 then represent a southern bypass of traffic disruption V, which only uses main roads 70 and represents an additional time requirement of 45 minutes, with the lowest traffic jam probability of 10% in comparison with first route 5. A sixth route 17 represents a first northern bypass of traffic disruption V, which also only uses main roads 70 and represents an additional time requirement of 15 minutes, with the highest traffic jam probability of 80% in comparison with first route 5. A seventh route 18 represents a second northern bypass of traffic disruption V, which represents an additional time requirement of 30 minutes, with an average traffic jam probability of 60%, which falls between the two indicated traffic jam probabilities. Also in the exemplary embodiment according to FIG. 4, the characteristics of the three alternative routes 16, 17, 18 to first route 5 can be represented adjacent to map 80 on the optical display device in order to facilitate the user's selection of one of the alternative routes to avoid traffic disruption V. In this context, according to FIG. 4, fifth route 16 is designated as route C, sixth route 17 as route A, and seventh route 18 as route B. In this context, as described, the traffic jam probability on fifth route 16 is 10%, on sixth route 17 is 80%, and on seventh route 18 is 60%, for example.

FIG. 10 shows a superimposition of the route representation according to FIG. 8 and of the representation of the information regarding the traffic flow by isolines according to FIG. 9. In this context, the same reference numerals again designate the same elements as in the previous figures. Superimposing the information regarding the traffic flow in conjunction with the representation of alternative routes 15, 20 increases the clarity for the user of navigational system 1 and simplifies and accelerates the user's selection of one of the two alternative routes 15, 20 for bypassing the traffic disruption, which is also designated as V in FIG. 10, on first route 5, the traffic disruption being located on the isosurface enclosed by isoline 0%, so that it is obvious that the traffic flow is congested there.

The user of navigational system 1 located at instantaneous position P then selects one of the alternative routes 15, 20 according to the exemplary embodiments in FIGS. 8 and 10 for avoiding traffic disruption V or one of the alternative routes 16, 17, 18 for avoiding traffic disruption V according to FIG. 4 at selection unit 900 and is directed by route guidance unit 800 on the selected route from instantaneous position P to destination Z to bypass traffic disruption V. Of course, the user is still able to select first route 5, if he does not wish to bypass traffic disruption V.

To bypass traffic disruption V, the user also has the option of creating and selecting his own alternative route in the previously described manner in order to be directed on the route to destination Z via route guidance unit 800. The described exemplary embodiment regarding the representation of information about traffic disruptions is only possible if communications unit 1000 is present in navigational device 1 or is assigned thereto. Otherwise, the alternative routes can only be calculated independently of information regarding such traffic disruptions. Without communications unit 1000, the alternative routes are also not actualized in accordance with the examples in FIGS. 4, 8, and 10.

In the previously described exemplary embodiments, the isosurface enclosed by an isoline indicates, in each case, the lightest traffic flow in the geographic region covered by the isosurface.

Message regions can either be specified at input unit 600 by the user or can be fixed in management unit 200 with a direct assignment to the route segments of map 80 stored in memory 100. In this context, there is a possibility in both cases to block specific roads or road segments, such as highway intersections, in the map view of map 80 on the optical display device. Such blocked roads or route segments are then not taken into consideration when determining alternative routes. If it is to be possible for the user to input message regions via input device 600, certain regions can be created by placing a surface object in the map view of map 80 on the optical display device, e.g. using cursor control. One or more alternative routes represented on the optical display device can also be modified by shifting proposed road segments on map 80 in a graphic or cursor-controlled manner, e.g. such that proposed route segments are shifted to non-proposed road segments, thereby altering the proposed alternative route. The proposed alternative routes can also be modified in that surface objects designating regions to be avoided are graphically added to the map in the described manner. As described, the road segments or regions to be avoided can be graphically moved by cursor control via a mouse pointer or cursor keys.

The alternative routes can be represented on map 80 in different manners, e.g. using different colors or different shades of color, so that the user can differentiate between them

For the case that qualitative traffic disruptions should or can also be indicated on map 80, if communications unit 1000 is provided, this can occur, for example, in that traffic disruption V is more closely characterized, e.g. as a traffic jam of 10 km due to an accident.

The representation of traffic disruptions in the form of isolines is not limited to the representation of the traffic flow, but can also be used for representing the maximum attainable speed, the traffic jam probability, the unavoidable time delay, or the like. In every case, the representation of the traffic disruptions in the form of isolines provides the user of navigational device 1, i.e., the driver of the motor vehicle, with particularly illustrative information regarding the intensity and extent of a traffic disruption. The same is true for representing traffic disruptions in the form of an isographic diagram, different colors or gradations of color or color intensities being able to be used to convey the gradations of the regions of minimum constant traffic flow, maximum attainable constant speed, lowest constant traffic jam probability, shortest constant time delay, etc.

The user of navigational system 1 enters destination Z via input unit 600. As described, calculation unit 400 subsequently calculates a plurality of routes in view of one or more route criteria from starting point S to destination Z.

If communications unit 1000 receives information regarding a traffic disruption on selected first route 5 while navigational system 1, i.e., the vehicle, is traveling from starting point S to destination Z, the information is represented as described in the form of isolines or an isographic diagram on the optical display device and is additionally signalized, e.g. by an acoustic signal tone, in order to alert the user of navigational system 1 to the changed situation on selected first route 5. The user operates a key at input unit 600 to confirm that he is aware of the information. Starting from instantaneous position P, the new alternative routes for bypassing traffic disruption V are subsequently calculated in the described manner and made visible on map 80, which is represented on the optical display device, so that the traffic disruption, the effects of it on the local surroundings of the traffic disruption, as well as the calculated alternative routes become visible at the same time.

The user of navigational system 1 can enter the selection for a proposed, calculated alternative route via input unit 600 by selecting one of the proposed alternative routes in a query menu on the optical display device, e.g. via cursor control, and confirming the selection, e.g. by operating a confirmation key. However, selection via verbal input, i.e., acoustically, or in another manner known to one skilled in the art can also be provided.

What is claimed is:

1. A navigational system (1) having a calculation unit (400) for calculating a first route (5) from a starting point (S) to a destination (Z) and having a reproducing device (700) for reproducing the calculated first route (5), wherein the calculation unit (400) calculates at least one second route (10), which differs from the first route (5), from starting point (S) to destination (Z); and the reproducing device (700) reproduces the at least one calculated second route (10) in addition to the first route (5).

2. The navigational system (1) as recited in claim 1, wherein a selection unit (900) for selecting one of the reproduced routes (5, 10) is provided; and a route guidance unit (800) is provided that generates navigational information for a position between the starting point (S) and the destination (Z) on the selected route (5) and transmits the information to the reproducing device (700) for reproduction.

3. The navigational device (1) as recited in claim 1 or 2, wherein the different routes (5, 10) are reproduced on the reproducing device (700) as a function of at least one predefined route criterion.

4. The navigational system (1) as recited in claim 3, wherein the traffic jam probability, travel time, speed, route distance, fuel consumption, regions through which the calculated routes should not travel, and/or the like can be specified as route criteria at an input unit (600) or can be fixed.

5. The navigational system (1) as recited in claim 3 or 4, wherein a weighting of the at least one route criterion can be specified at the input unit (600) or can be fixed.

6. The navigational system (1) as recited in one of the preceding claims, wherein input means (605) for manipulating or changing at least one of the routes (5, 10) reproduced on the reproducing device (700) are provided, and a manipulated or altered route can be selected for route guidance.

7. The navigational system (1) as recited in one of the preceding claims, wherein a communications unit (1000) is provided that receives information regarding traffic disruptions, in particular regarding the traffic flow, on the calculated routes (5, 10); and the reproducing device (700) reproduces this information.

8. The navigational system (1) as recited in claim 7, wherein the reproducing device (700) reproduces the information regarding the traffic disruptions in conjunction with the calculated routes (5, 10).

9. The navigational system (1) as recited in claim 7, wherein the reproducing device (700) reproduces the information regarding the traffic disruptions separately from the calculated routes (5, 10).

10. The navigational system (1) as recited in claim 7, 8, or 9, wherein the reproducing device (700) reproduces the traffic disruptions in the form of isolines (25, 30, 35, 40, 45, 50).

11. The navigational system (1) as recited in claim 7, 8, or 9, wherein the reproducing device (700) reproduces the traffic disruptions in the form of an isographic diagram (55).

12. The navigational system (1) as recited in one of claims 7 through 11, in one of the preceding claims, wherein, in response to receiving information regarding a traffic disruption on the selected route (5), the calculation unit (400) calculates at least one additional route (15, 20; 16, 17, 18), which differs from the selected route (5), starting from the instantaneous position (P) as the new starting point to the predefined destination (Z); and the reproducing device (700) reproduces for selection the at least one calculated additional route (15, 20; 16, 17, 18) in addition to the selected route (5).

13. The navigational system (1) as recited in one of claims 7 through 12, wherein the received information also includes the type of traffic disruption, and the reproducing device (700) reproduces the type of traffic disruption.

14. The navigational system (1) as recited in one of the preceding claims, wherein the reproduction at reproducing device (700) is optical and/or acoustic.
